(19) United States
(12) Patent Application Publication
(10) Pub. No.: US 2025/0023337 A1
(43) Pub. Date: Jan. 16, 2025

(54) DEAD END CABLE FITTINGS

(71) Applicant: Preformed Line Products Company, Mayfield, OH (US)

(72) Inventors: Ben Ciesielczyk, Madison, OH (US); Jacob Palmer, Chesterland, OH (US)

(21) Appl. No.: 18/219,896

(22) Filed: Jul. 10, 2023

(51) Int. Cl. H02G 15/06; H01B 11/00; H01B 11/18

(52) U.S. Cl. CPC H02G 15/06; H01B 11/007; H01B 11/1895

(57) ABSTRACT

Disclosed herein are dead end fittings for securing cables with a non-circular external profile. The dead end fittings include an arcuate portion, a first helical leg that extends from one end of the arcuate portion, and a second helical leg that extends from an opposite end of the arcuate portion. Each of the first and second helical legs define a non-circular internal profile that matches the non-circular external profile of the cable.

### BACKGROUND

The present specification generally relates to dead end fittings and assemblies for use in securing cables, and in particular, to fittings for use with a non-circular cable.

In applications where a cable span is required between two points, it is known to secure the cable using fittings that grip the cable and are attached to suitable fixings. A typical application for such dead end fittings is in an aerial cable span between a pole and a building, for example in cables for communication applications.

Conventional dead end fittings may include structural reinforcing rods having a helical form. In particular, these fittings typically include a looped component with helical legs that attach to the cable by wrapping the helical legs around the cable such that the cable is gripped within an internal profile of the helical legs. The fitting then attaches to a suitable fixing using the looped component.

The helical legs of conventional dead end fittings have an internal profile that is circular in shape to match the external circular profile of the cable being gripped. However, cables have been introduced to the market that have an external profile that is non-circular in shape, such as flat drop cables, for example. Cables with non-circular shapes are difficult to grip with a conventionally formed fitting having helical legs with a circular internal profile. This is because the circular internal profile of the helical legs does not match the non-circular external profile of the cable, resulting in less surface contact area between the helical legs and the cable.

Accordingly, a need exists for improved dead end fittings that secure cables having a non-circular external profile.

### SUMMARY

In one embodiment, an apparatus includes an elongated fitting including an arcuate portion, a first helical leg that extends from one end of the arcuate portion, and a second helical leg that extends from an opposite end of the arcuate portion. Each of the first and second helical legs define a non-circular internal profile.

In another embodiment, an apparatus for supporting a cable having a non-circular external profile includes an elongated fitting that includes an arcuate portion, a first helical leg that extends from one end of the arcuate portion and is wrapped around the cable, and a second helical leg that extends from an opposite end of the arcuate portion and is wrapped around the cable. Each of the first and second helical legs define a double helix disposed around the cable that has a non-circular internal profile and the non-circular internal profile of the double helix matches the non-circular external profile of the cable.

In yet another embodiment, a method includes providing an elongated fitting that includes an arcuate portion, a first helical leg extending from one end of the arcuate portion, and a second helical leg extending from an opposite end of the arcuate portion; and forming a non-circular internal profile in the first and second helical legs.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts an environment in which the dead end fittings of the disclosure may be used, according to one or more embodiments shown and described herein;

FIG. 2 schematically depicts a dead end assembly that includes a dead end fitting and a cable gripped within the fitting, according to one or more embodiments shown and described herein;

FIG. 3A schematically depicts a cross-section taken along line A-A of FIG. 2 of a conventional dead end assembly including a dead end fitting and a circular cable gripped within the fitting;

FIG. 3B schematically depicts a cross-section taken along line A-A of FIG. 2 of a conventional dead end assembly including a dead end fitting and a non-circular cable gripped within the fitting; and

FIG. 4 schematically depicts a cross-section taken along line A-A of FIG. 2 of a dead end assembly including a dead end fitting and a non-circular cable, according to one or more embodiments shown and described herein.

### DETAILED DESCRIPTION

Embodiments described herein are directed to a dead end fitting that includes a non-circular internal profile to secure cables having a non-circular external profile. The dead end fitting generally includes an elongated member with an arcuate portion and helical legs that extend from the arcuate portion and define the non-circular internal profile. Various embodiments of the dead end fitting, a method of forming the non-circular internal profile of the dead end fitting, and the operation of the dead end fitting and method of forming the non-circular internal profile are described in more detail herein. Whenever possible, the same reference numerals will be used throughout the drawings to refer to the same or like parts.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

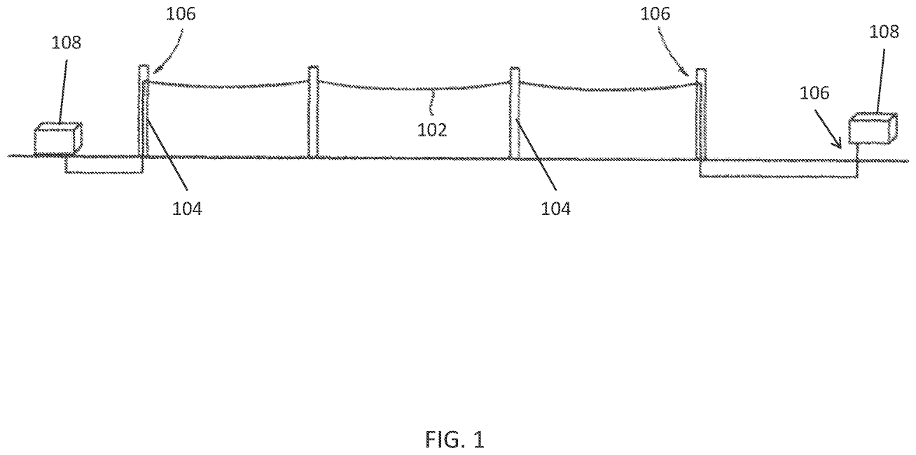

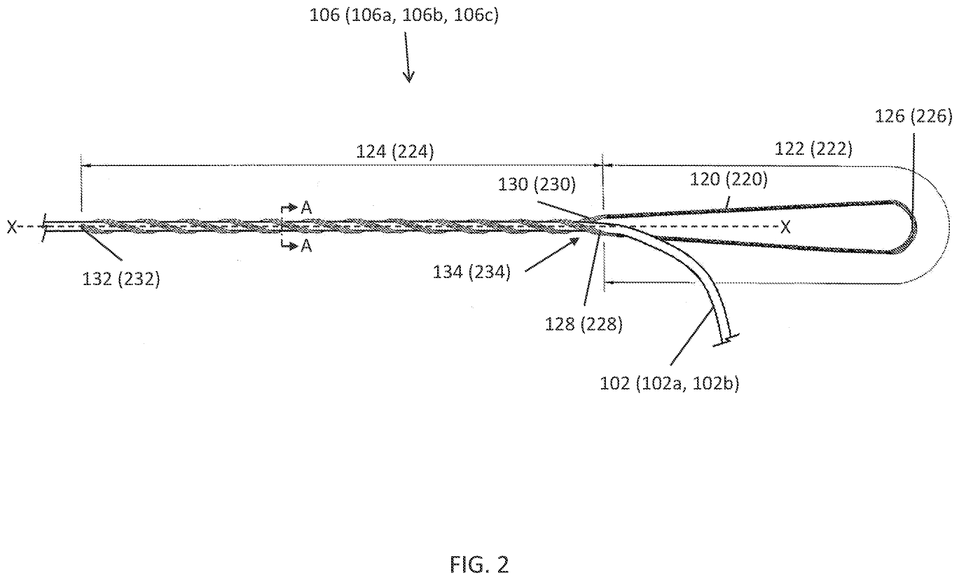

As shown in FIG. 1, dead end assemblies 106 as described herein are used to attach an end of a cable 102, such as a fiber optic cable or All-Dielectric Self-Supporting (“ADSS”) cable, for example, to a utility pole 104, a building 108 or other structure. The dead end assemblies 106 are able to maintain tension on the cable 102 and are capable of transferring the load of the cable 102 to a holding device or fitting 120 (FIG. 2) of the dead end assembly 106.

The dead end assembly 106 is illustrated in greater detail with reference to FIG. 2 and generally includes the fitting 120 and the cable 102 which is gripped by the fitting 120. The fitting 120 is an elongated member that generally includes two main sections, a loop portion 122 and a gripping portion 124. The fitting 120 is formed into an arcuate segment 126 with two extending helical legs 128, 130. The fitting 120 is typically made from wire (e.g., galvanized steel, aluminum, aluminized steel, mischmetal coated steel, or stainless steel), plastic, or any other suitable weatherproof material, and may include several wires bonded together to form a single component. The material of the fitting 120 may be uncoated or coated to blend in with the cable or the surroundings.

When applied to the cable 102, as shown in FIG. 2, the helical legs 128, 130 are wrapped around the cable 102 to effectively form a double helix with the cable 102 running along a central axis line X-X, and the arcuate segment 126 forming the loop portion 122 at one end of the fitting 120. The loop portion 122 extends from the crossover point 134 to the arcuate segment 126 at one end of the fitting 120. The legs 128, 130 grip the cable 102, and the fitting 120 can be used to attach the cable 102 to a fixing point via the loop portion 122, e.g., by attaching the loop 122 to a suitable attachment member (not shown) such as a hook, bracket, or any other suitable fixing. In order to position the cable 102 across a span, an attachment member would typically be provided at each end of the span, attached to respective fixing points.

The gripping portion 124 of the fitting 120 is formed by the double helix of the helical legs 128, 130, wrapped around the cable 102 as described above. When the fitting 120 is in position on a cable, the gripping portion 124 extends from an end 132 of the fitting 120, corresponding to the distal ends of the helical legs 128, 130, to a crossover point 134 located adjacent to the arcuate segment 126. The crossover point 134 is the point at which the double helix ends and the cable 102 exits the fitting 120 and drops downwards, or in another direction as desired. The gripping portion 124 enables the fitting 120 to grip the cable 102, and transfers the tensile load on the cable 102 to the fitting 120. The helical legs 128, 130 may be of different lengths, so that the legs end at different points on the cable 102 at the end 132 of the fitting 120. That is, the distal end of one of the helical legs 128, 130 may extend further than the other helical leg. Furthermore, the distal ends of the legs 128, 130 may be shaped so as to be angled away from the cable 102 when the fitting 120 is in position. This prevents the ends of the legs 128, 130 from scoring the cable 102 during application, or when in position, which could reduce the breaking load or otherwise damage the cable 102.

The gripping portion 124 may be provided with a controlled amount of grit applied to the internal surface of the helical legs 128, 130, in order to assist in gripping the exterior of the cable 102. Other suitable additives or coatings, or surface finishes such as knurling, may also be used to achieve a similar effect. The grip provided on the cable 102 by the fitting 120 can be controlled to provide a desired effect in the event that the cable tension reaches a predetermined threshold. Either the grip can be sufficient that the cable 102 breaks when the threshold tension is reached, or the grip provided by the fitting 120 can be arranged to allow the cable 102 to slip with a controlled slip load, before the breaking tension is reached.

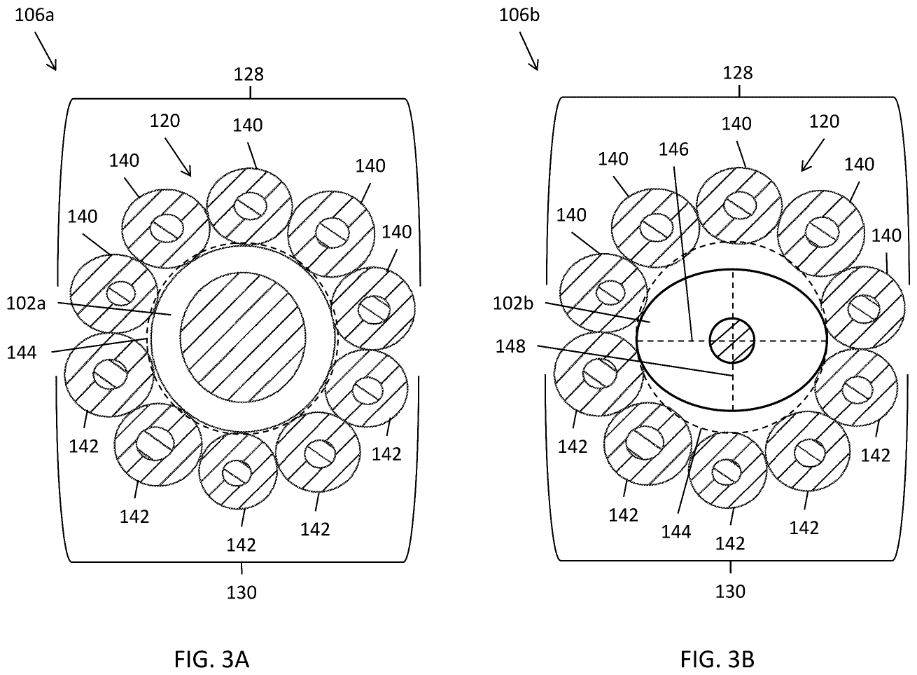

The double helix formed when the helical legs 128, 130 are wrapped around the cable 102 generally forms an axial opening or channel in which the cable 102 is housed. The axial opening extends along the gripping portion 124 and defines an internal profile or diameter. Existing dead end assemblies use fittings that have a generally circular internal profile extending along the gripping portion thereof in order to match the typically circular external profile of a cable to be gripped. As such, the surface contact area between the cable and the fitting is maximized to allow for greater gripping or holding strength. This is demonstrated by the sectional view of the dead end assembly 106a in FIG. 3A, as viewed from the perspective indicated by lines A-A of FIG. 2.

In the section view of FIG. 3A, the dead end assembly 106a generally includes fitting 120 and a standard circular cable 102a gripped within the fitting 120. Individual strands or wires 140 make up the first helical leg 128 of the fitting 120 and individual strands or wires 142 make up the second helical leg 130 of the fitting 120. While five individual strand or wires 140, 142 are illustrated in FIG. 3A as forming each of the helical legs 128, 130, respectively, it is contemplated that the helical legs may be formed from more or less individual strands or wires as desired. Moreover, the individual strands or wires 140, 142 are illustrated with a coating applied thereon which may assist in gripping the cable 102a. However, it should be understood that the individual strands or wires 140, 142 may be formed without a coating as desired. Together, the helical legs 128, 130 define a double helix with an internal profile 144 that is circular in shape to match the circular external profile of the cable 102a. The surface contact area is maximized because the internal profile 144 defined by the helical legs 128, 130 matches the external profile of the cable 102a.

However, recent market trends have seen a move toward the use of non-circular cables, such as flat-drop cables, figure-8 cables, bowtie cables, and any other cable having a generally oblong external profile. In such use cases, existing dead end assemblies still use fittings that have a generally circular internal profile extending along the gripping portion thereof. However, cables with non-circular shapes are difficult to consistently hold with a standard formed fitting that has a circular internal profile due to the lack of contact surface area between the fitting and the non-circular cable. This is demonstrated by the sectional view of the dead end assembly 106b in FIG. 3B, as viewed from the perspective indicated by lines A-A of FIG. 2.

In the section view of FIG. 3B, the dead end assembly 106b generally includes fitting 120 and a flat drop cable 102b gripped within the fitting 120. However, other cable types as discussed above may be used. Individual strands or wires 140 make up the first helical leg 128 of the fitting 120 and individual strands or wires 142 make up the second helical leg 130 of the fitting 120. Together, the helical legs 128, 130 define a double helix having an internal profile 144 that is circular in shape. However, the circular internal profile 144 of the double helix does not match the non-circular external profile of the flat drop cable 102b. As such, the helical legs 128, 130 can only grip the two narrow ends of the major axis 146 of the flat drop cable 102b. The two wide ends of the minor axis 148 of the flat drop cable 102b generally have no or very little surface contact area with the helical legs 128, 130. As a result, the gripping or holding strength is reduced which may cause undesirable slippage of the flat drop cable 102b from the helical legs 128, 130 of the fitting 120.

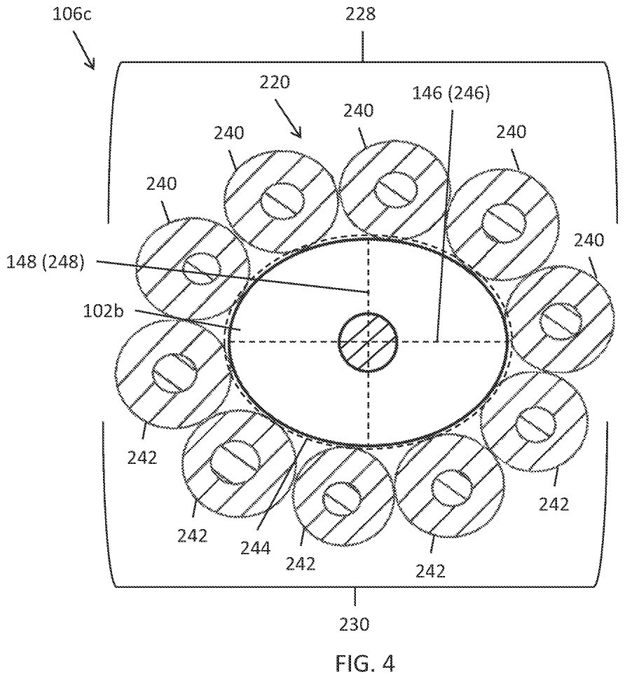

Turning now to FIG. 4, a dead end assembly 106c is illustrated in a section view, as viewed from the perspective indicated by lines A-A of FIG. 2, in accordance with one embodiment of the disclosure. The dead end assembly 106c generally includes fitting 220 and flat drop cable 102b gripped within the fitting 220. The fitting 220 is generally formed to have features which are substantially similar to features of fitting 120 described above. Thus, with reference to FIG. 2, fitting 220 includes a loop portion 222, gripping portion 224, arcuate segment 226, first helical leg 228, second helical leg 230, end 232, and crossover point 234. Moreover, similar to fitting 120 described above, individual strands or wires 240 make up the first helical leg 228 of the fitting 220 and individual strands or wires 242 make up the second helical leg 230 of the fitting 220.

However, different from fitting 120 described above, the helical legs 228, 230 of fitting 220 together define a double helix having an internal profile 244 that is non-circular in shape to match the non-circular external profile of the cable 102b. The surface contact area is maximized because the internal profile 244 defined by the helical legs 228, 230 matches the external profile of the flat drop cable 102b. In other words, at least a portion of each of the individual strands or wires 240 of the first helical leg 228 and each of the individual strands or wires 242 of the second helical leg 230 is in contact an outer surface of the cable 102b. As such, the helical legs 228, 230 can adequately grip the two narrow ends of the major axis 146 and the two wide ends of the minor axis 148 of the external profile of the flat drop cable 102b. In this regard, the non-circular internal profile 244 formed by helical legs 228, 230 also includes a major and minor axis 246, 248, respectively. Due to the matching of the non-circular internal profile 244 to the non-circular external profile of the cable 102b, the major axes 146, 246 are substantially identical in dimension and the minor axes 148, 248 are substantially identical in dimension.

It should be noted that while FIG. 4 illustrates the non-circular internal profile 244 formed by helical legs 228, 230 as having an elliptical or oblong shape, the disclosure is not limited thereto and other shapes are contemplated. For example, the non-circular internal profile 244 may have a pill shape if a pill-shaped cable is used in the dead end assembly 106c. In other examples, the non-circular internal profile 244 may have a figure-8 shape, a bowtie shape, and any other shape having a generally oblong profile. In some embodiments, the non-circular internal profile 244 can be any shape having a major axis (such as major axis 246) and a minor axis (such as minor axis 248). In some embodiments, the major axis may have a dimension of between about 7.0 mm to about 9.0 mm, and the minor axis may have a dimension of between about 4.0 to about 5.0 mm. In some particular embodiments, the major and minor axes 246, 248 may be selected from the following dimensions (i.e., major axis (mm) x minor axis (mm)): about 8.1 mm×about 4.5 mm, about 7.8 mm×about 4.3 mm; about 8.3 mm×about 4.3 mm; about 7.7 mm×about 4.3 mm; or about 7.4 mm×about 4.4 mm.

From the above, it is to be appreciated that defined herein is a dead end fitting that includes a non-circular internal profile to secure cables having a non-circular external profile.

It will be apparent to those skilled in the art that various modifications and variations can be made to the embodiments described herein without departing from the scope of the claimed subject matter. Thus, it is intended that the specification cover the modifications and variations of the various embodiments described herein provided such modification and variations come within the scope of the appended claims and their equivalents.

1. An apparatus comprising:
an elongated fitting including an arcuate portion, a first helical leg that extends from one end of the arcuate portion, and a second helical leg that extends from an opposite end of the arcuate portion;
wherein each of the first and second helical legs define a non-circular internal profile.

2. The apparatus of claim 1, wherein the internal profile is elliptical, oblong, pill shaped, figure-8 shaped, or bowtie shaped.

3. The apparatus of claim 1, wherein the first and second helical legs are wrapped together to form a double helix having the non-circular internal profile.

4. The apparatus of claim 3, wherein the double helix having the non-circular internal profile extends between a distal end of the first and second helical legs and a crossover point located adjacent to the arcuate portion.

5. The apparatus of claim 1, wherein a distal end of one of the first or second helical legs extends further than the other first or second helical leg.

6. The apparatus of claim 1, wherein the non-circular internal profile includes a major axis and a minor axis.

7. The apparatus of claim 1, wherein at least one of the first or second helical legs is provided with a surface finish or surface coating.

8. The apparatus of claim 7, wherein the surface coating comprises grit provided on an internal surface of at least one of the first or second helical legs.

9. The apparatus of claim 7, wherein the surface finish comprises knurling provided on an internal surface of at least one of the first or second helical legs.

10. The apparatus of claim 1, wherein the elongated fitting is made of galvanized steel wire, stainless steel, aluminum, mischmetal coated steel, or aluminized steel wire.

11. An apparatus for supporting a cable, the cable having a non-circular external profile, the apparatus comprising:
an elongated fitting including an arcuate portion, a first helical leg that extends from one end of the arcuate portion and is wrapped around the cable, and a second helical leg that extends from an opposite end of the arcuate portion and is wrapped around the cable,
wherein each of the first and second helical legs define a double helix disposed around the cable, the double helix having a non-circular internal profile, and
wherein the non-circular internal profile of the double helix matches the non-circular external profile of the cable.

12. The apparatus of claim 11, wherein the non-circular internal profile of the double helix and the non-circular external profile of the cable is elliptical, oblong, pill shaped, figure-8 shaped, or bowtie shaped.

13. The apparatus of claim 11, wherein the double helix forms a cable gripping portion that extends between a distal end of the first and second helical legs and a crossover point located adjacent to the arcuate portion.

14. The apparatus of claim 13, wherein the cable gripping portion is provided with a surface finish or surface coating.

15. The apparatus of claim 11, wherein the first and second helical legs are each formed of a plurality of wires and at least a portion of each wire in the plurality of wires is in contact with an outer surface of the cable.

16. The apparatus of claim 11, wherein the non-circular internal profile of the double helix includes a major axis and a minor axis.

17. A method comprising:
providing an elongated fitting including an arcuate portion, a first helical leg extending from one end of the arcuate portion, and a second helical leg extending from an opposite end of the arcuate portion; and
forming a non-circular internal profile in the first and second helical legs.

18. The method of claim 17, wherein the internal profile is elliptical, oblong, pill shaped, figure-8 shaped, or bowtie shaped.

19. The method of claim 17, further comprising wrapping the first and second helical legs together to form a double helix having the non-circular internal profile.

20. The method of claim 17, wherein forming the non-circular internal profile further comprises forming a major axis and a minor axis in each of the first and second helical legs.
